(19) United States
(12) Patent Application Publication
(10) Pub. No.: US 2002/0120655 A1
(43) Pub. Date: Aug. 29, 2002

(54) Pen type step calculating device

(76) Inventors: Ko-Chien Liu, Hsin-Dien City (TW); Yi-Chia Shen, Taipei City (TW); Ching-Piao Lin, Ban-Chiao City (TW)

Correspondence Address: Hart, Baxley, Daniels & Holton, 59 John Street, Fifth Floor, New York, NY, 10038, US

(21) Appl. No.: 09/792,925

(22) Filed: Feb. 26, 2001

(51) Int. Cl. G06F 3/00

(52) U.S. Cl. 708/133

(57) ABSTRACT

The present invention relates to a pen type step calculating device that uses vertical vectors with assistance of horizontal vectors of a sensing microswitch. The detection of the sensing microswitch achieves a sampling effect. The successive digital signals of the OFF/ON status are in turn accumulated by the calculator, and are then indicated on the LCD display board through an I/O circuit, thereby completely excluding possibility of calculating the values erroneously, and thereby efficiently enhancing the utility of the pen type step calculating device.

### BACKGROUND OF THE INVENTION

1. Field of the Invention

The present invention relates to a pen type step calculating device, and more particularly to a pen type step calculating device that uses vertical vectors with assistance of horizontal vectors of a sensing microswitch.

2. Description of the Related Prior Art

A conventional step calculator in accordance with the prior art may be used to calculate the numbers of steps of the user during walking or running, whereby the numbers of steps correspond to the values of heat consumption, so that the user can obtain the calories consumed during walking or running.

The conventional step calculator contains therein a microswitch of a mercury type, a voltage type or a mechanic type, for detecting the variation of vector due to vibration of the human body. However, the mounting position of the microswitch is not correct, or the sensitivity of the microswitch is not efficient, so that the microswitch cannot measure the actual values accurately.

### SUMMARY OF THE INVENTION

In accordance with the present invention, there is provided a pen type step calculating device comprising:

a barrel having an upper portion and a lower portion, an opening defined in the upper portion of the barrel;

a transparent outer cover mounted in the opening of the barrel;

a battery sleeve mounted in the upper portion of the barrel and containing at least one battery therein;

a sensing circuit board mounted in the upper portion of the barrel and connected to the battery sleeve; and

a press button switch mounted in the upper portion of the barrel and connected to the sensing circuit board;

wherein, the sensing circuit board includes:

an LCD display board for displaying steps/distance/heat capacity;

a sensing microswitch respectively for detecting changes of vertical vectors and horizontal vectors;

an LED for providing status display;

a calculator for receiving digital signals so as to execute an accumulative operation;

a comparator for providing comparison of values; and

a decoder containing an operation unit therein.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a pen type step calculating device in accordance with the present invention;

FIG. 2A is a front plan cross-sectional assembly view of the pen type step calculating device as shown in FIG. 1;

FIG. 2B is a partially enlarged view of the pen type step calculating device as shown in FIG. 2A;

FIG. 3 is a block view of a sensing circuit board of the pen type step calculating device in accordance with the present invention;

FIG. 4 is a circuit view of the sensing circuit board of the pen type step calculating device in accordance with the present invention;

FIG. 5A is a schematic view of a press button switch of the pen type step calculating device in accordance with one embodiment of the present invention;

FIG. 5B is a schematic operational view of the press button switch of the pen type step calculating device as shown in FIG. 5A;

FIG. 6 is a perspective assembly view of the pen type step calculating device as shown in FIG. 1;

FIG. 7A is a schematic view of a press button switch of the pen type step calculating device in accordance with another embodiment of the present invention;

FIG. 7B is a schematic operational view of the press button switch of the pen type step calculating device as shown in FIG. 7A;

FIG. 7C is a schematic operational view of the press button switch of the pen type step calculating device as shown in FIG. 7A;

FIG. 8A is a perspective assembly view of the pen type step calculating device as shown in FIG. 1; and

FIG. 8B is a schematic operational view of the pen type step calculating device as shown in FIG. 8A.

### DETAILED DESCRIPTION OF THE INVENTION

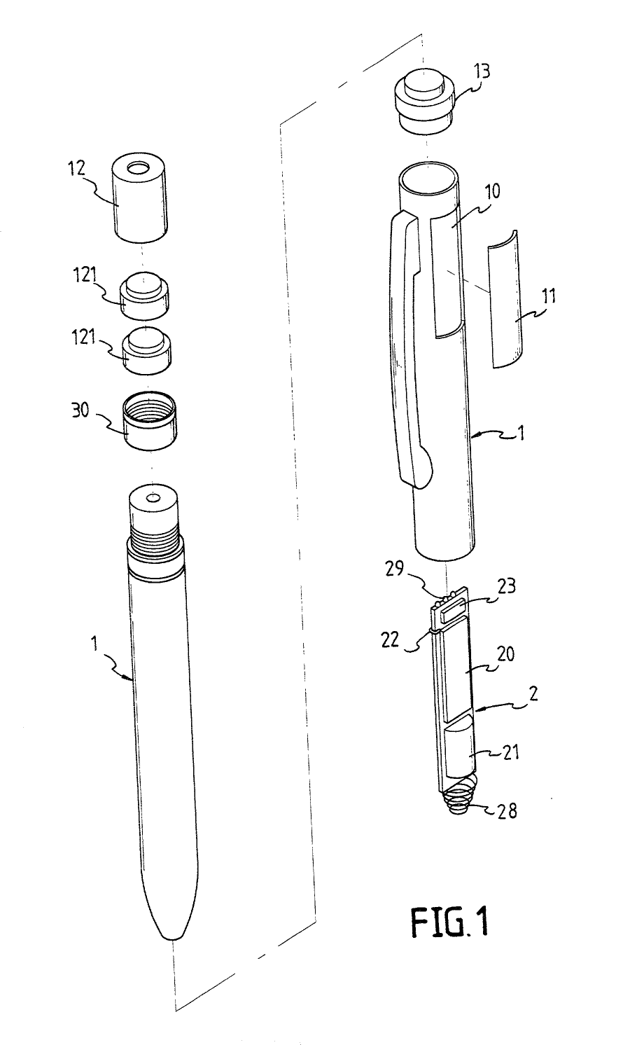

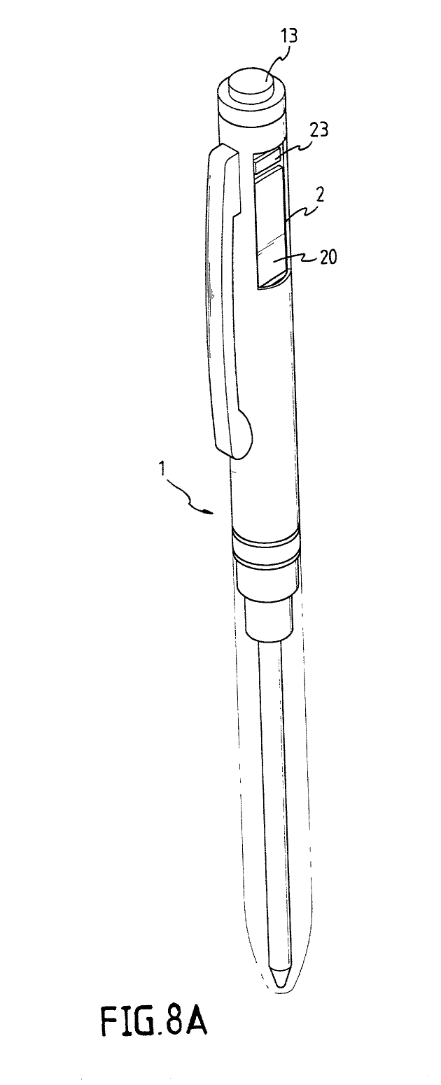

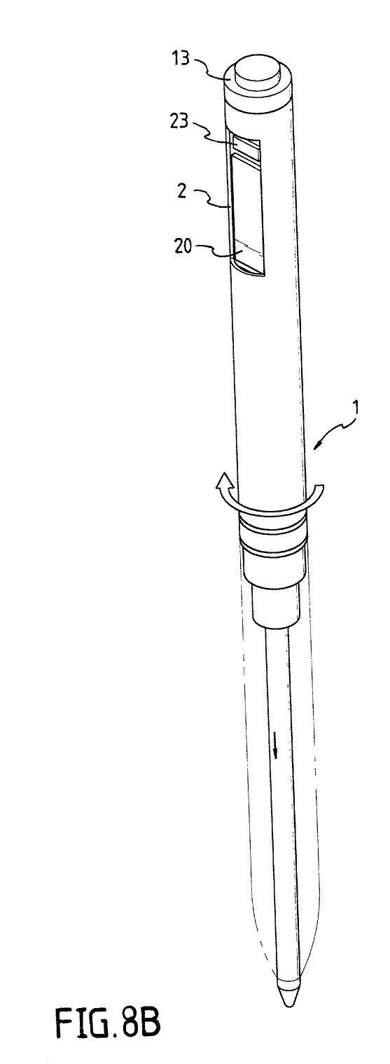

Referring to the drawings and initially to FIG. 1, a pen type step calculating device in accordance with the present invention comprises a barrel 1 having an upper portion and a lower portion. As shown in FIGS. 8A and 8B, the upper portion and the lower portion of the barrel 1 are rotated in the opposite directions, so that the tip of the pen can expand outward from or retract into the barrel 1. In addition, the upper portion and the lower portion of the barrel 1 are combined with each other by an inner threaded bushing 30.

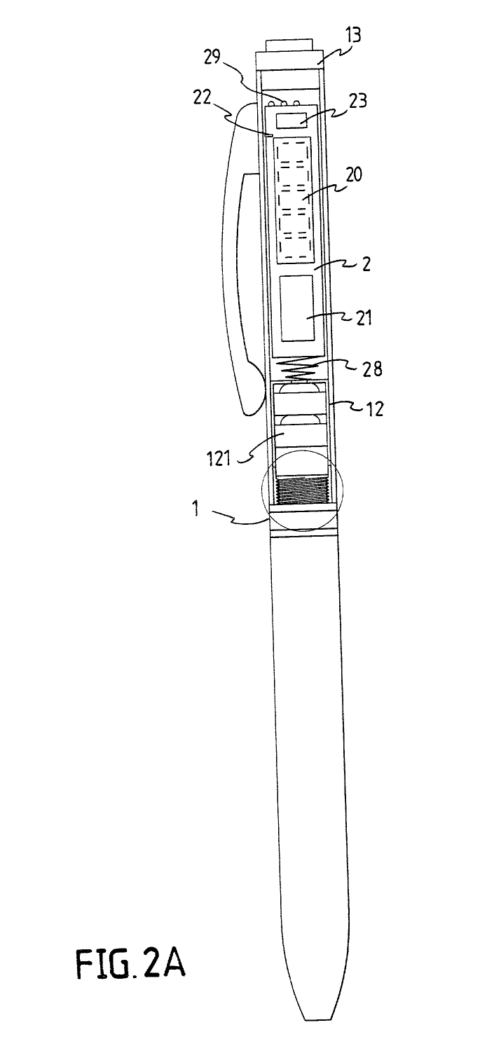

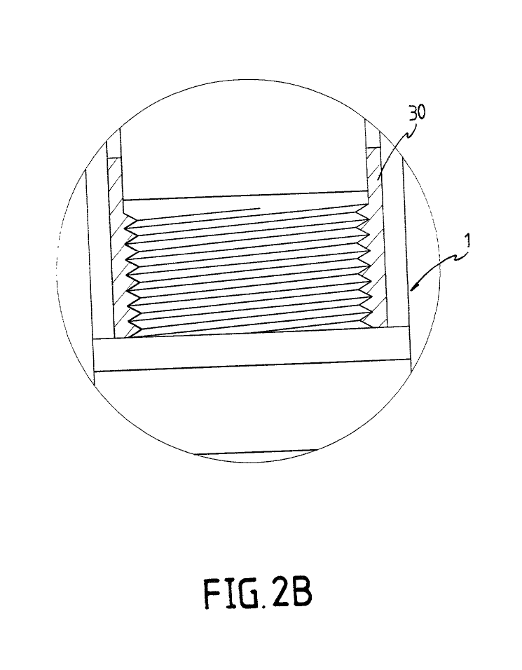

As shown in FIGS. 1 and 2, an opening 10 is defined in the upper portion of the barrel 1, and a transparent outer cover 11 is mounted in the opening 10 of the barrel 1. A plastic battery sleeve 12 is mounted in the upper portion of the barrel 1 and contains two batteries 121 therein. A sensing circuit board 2 is mounted in the upper portion of the barrel 1 and is connected to the battery sleeve 12. A press button switch 13 is mounted in the upper portion of the barrel 1 and is connected to the sensing circuit board 2. One end of the plastic battery sleeve 12 has a through hole allowing passage of a spring 28 mounted on one end of the sensing circuit board 2. The spring 28 is connected to the positive electrode of the battery 121 contained in the battery sleeve 12. The inner hole of the battery sleeve 12 and the negative electrode of the battery 121 are connected to the PIN leg of the wall of the barrel 1, thereby conducting the circuit. The battery sleeve 12 may also be used to support the sensing circuit board 2.

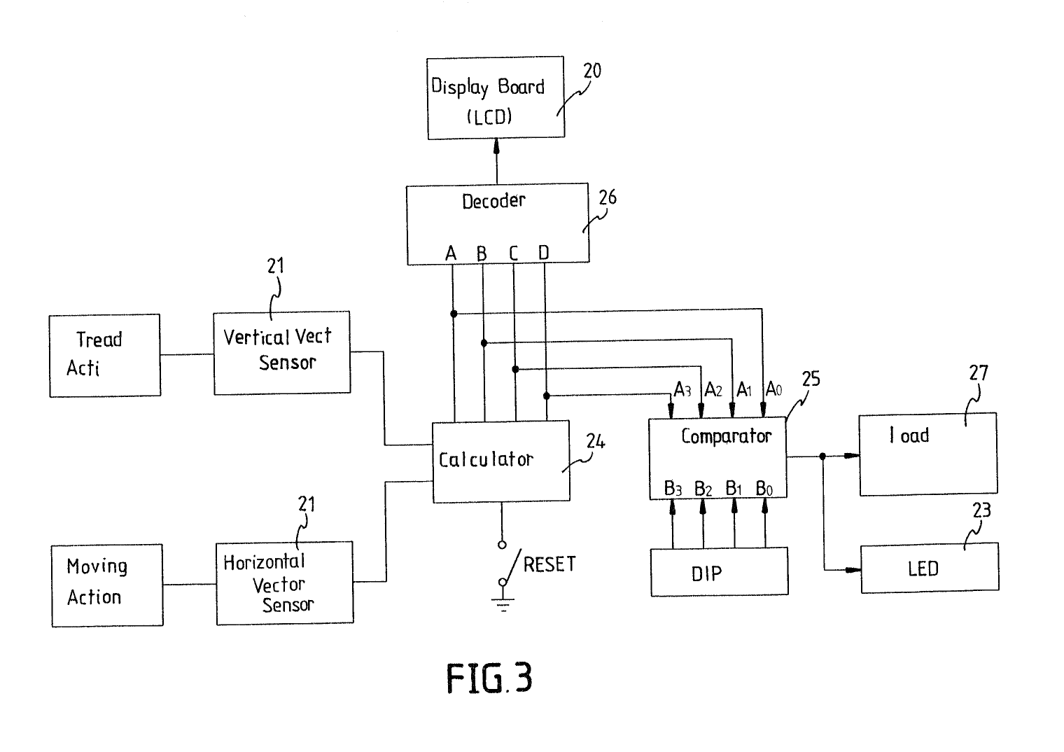

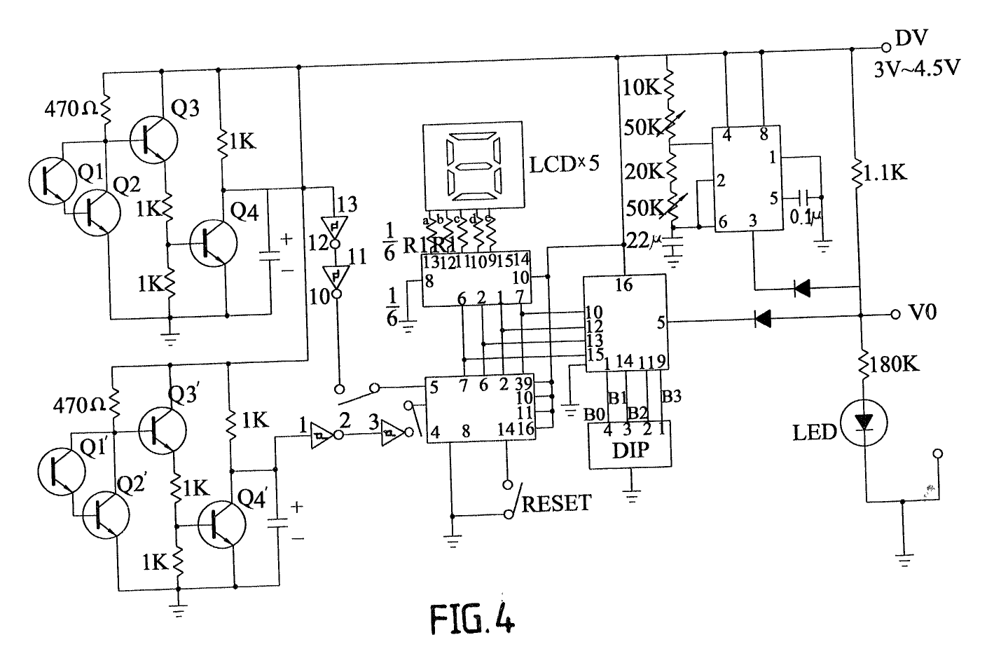

Referring to FIGS. 3 and 4, the sensing circuit board 2 includes: an LCD display board 20 having five numbers mounted thereon for providing display of the steps/distance (kilometer)/heat capacity (calorie); a sensing microswitch 21 respectively for detecting changes of vertical vectors and horizontal vectors; a metallic wire 22 for grounding; a SMT type double colored LED 23 for providing status display; a calculator 24 for receiving digital signals to execute an accumulative operation; a comparator 25 for providing comparison of values; a decoder 26 containing an operation unit therein; and a load such as a buzzer 27 or a motor.

A spring 28 is mounted in the upper portion of the barrel 1 and is connected between the battery sleeve 12 and a first end of the sensing circuit board 2, and an electrode 29 is mounted in the upper portion of the barrel 1 and is connected between the press button switch 13 and a second end of the sensing circuit board 2. Thus, when the spring 28 and the electrode 29 are placed in the barrel 1, the spring 28 and the electrode 29 are respectively in contact and conduct with the battery sleeve 12 and the press button switch 13. The LCD display board 20 is exactly placed in the opening 10, thereby facilitating inspection of the user. In addition, the buzzer 27 can be deleted.

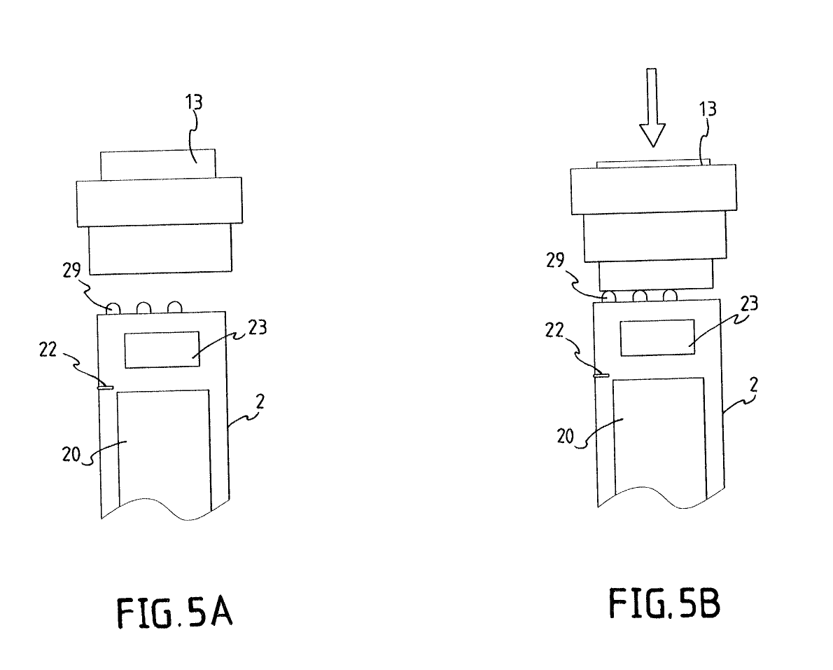

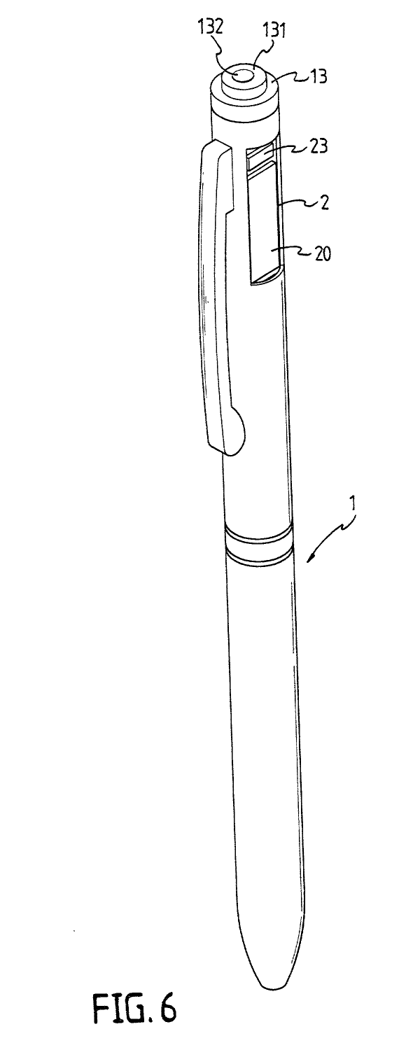

Referring to FIGS. 5A and 5B, the press button switch 13 has a single cylindrical press button type, thereby simplifying the construction.

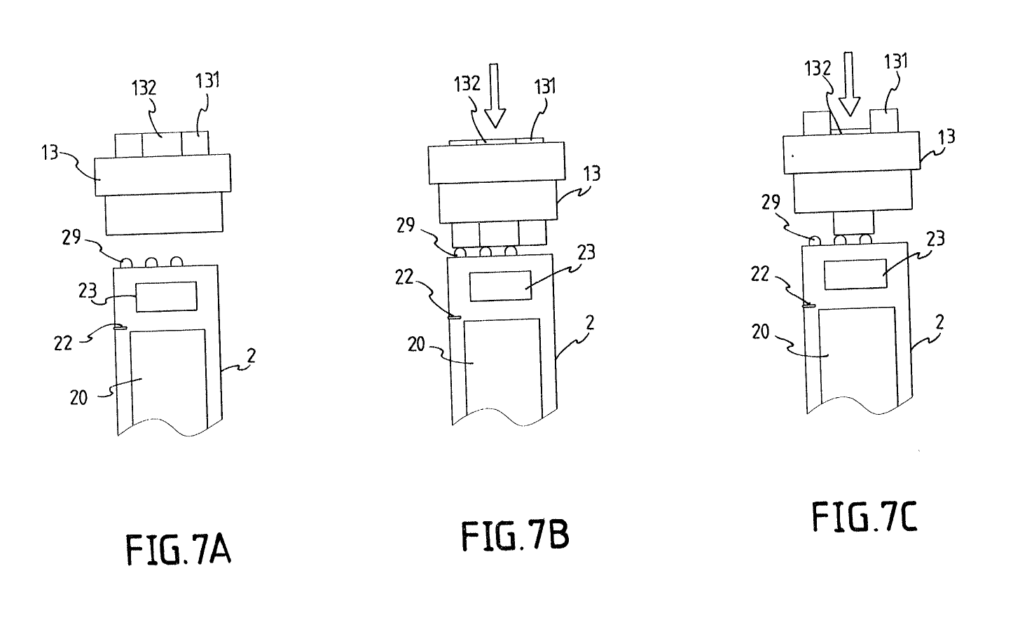

Referring to FIGS. 7A, 7B and 7C, the press button switch 13 includes a large circle 131 and a small circle 132 arranged in a concentric manner to mate with the electrode 29 respectively, thereby forming a conducting statue. When the large circle 131 and the small circle 132 are pressed simultaneously, all of three points of the electrode 29 are disposed at the “ON” status, and when the small circle 132 is pressed, only two points of the electrode 29 are disposed at the “ON” status, thereby achieving the effect of having various functional selections.

When is use, the pen type step calculating device of the present invention is fitted on the user's body. When the user lifts his leg, the upward vertical vector is changed, and when the user is moving forward or backward, the center of gravity of the user's body is shifted, thereby forming the change of the horizontal vector. Thus, before action of the user, the microswitch 21 of the pen type step calculating device is stationary to have an “OFF” status. When the user lifts his leg, the microswitch 21 of the pen type step calculating device is also disposed at the “OFF” status. When the user's leg is lowered to tread on the ground, the microswitch 21 is conducted to form the “ON” status. But, this sensing mode cannot efficiently exclude the erroneous action of stepping at the original place. Therefore, the microswitch 21 that can detect the change of the horizontal vector is used, whereby, when the user is stationary or when the user only lifts his leg, the microswitch 21 is still disposed at the “OFF” status. When the center of gravity of the user's body is shifted, that is, the user is moving, the microswitch 21 is disposed at the “ON” status, and when the user is stationary or only lifts his leg, the microswitch 21 is disposed at the “OFF” status.

Referring to FIGS. 5A and 5B, the press button switch 13 has a single cylindrical press button type, so that the pen type step calculating device functions as a common pen structure having a single press button switch. When the battery is fitted, the pen type step calculating device is conducted to form an “ON” status, and the press button switch 13 having a single cylinder functions as a “RESET” switch. When the battery is removed, the pen type step calculating device is disposed at an “OFF” status. In such a manner, the LCD can save the electric power, and has a longer lifetime.

Referring to FIGS. 7A, 7B and 7C, the press button switch 13 includes a large circle 131 and a small circle 132. The pen type step calculating device can also function as a common pen structure. When the large circle 131 of the press button switch 13 is pressed, the numbers of steps are displayed. The numbers of steps multiplying 70 cm will obtain the actual distance of travel (N steps multiplying 0.0007 km). When the small circle 132 is pressed, the numbers are reset, to recalculate the steps. When the large circle 131 of the press button switch 13 is pressed at the first time, the LCD display board 20 will show the numbers of steps. If the numbers of steps are smaller than 10000, the red light on the LED 23 will blink, and if the numbers of steps are greater than 10000, the green light on the LED 23 will blink. When the large circle 131 of the press button switch 13 is pressed at the second time, the LCD display board 20 will show the distance of travel. If the distance of travel is smaller than 7 km, the red light on the LED 23 will blink, and if the distance of travel is greater than 7 km, the green light on the LED 23 will blink. When the large circle 131 of the press button switch 13 is pressed at the third time, the LCD display board 20 will show the values of heat consumption. If the values of heat consumption are smaller than 4000 calories, the red light on the LED 23 will blink, and if the values of heat consumption are greater than 4000 calories, the green light on the LED 23 will blink.

Before installation of the battery, 30 seconds are allowed to set the time of the pen structure. If the preset time is exceeded, the battery has to be removed for reset the time. The small circle 132 of the press button switch 13 is initially pressed, to start the function of calculating the steps, and reducing the values to zero. Then, the large circle 131 of the press button switch 13 is successively pressed, so that the LCD can serially indicate the original time, the numbers of steps, the distance of travel, and the values of heat consumption, thereby obtaining the required functions.

Accordingly, the pen type step calculating device in accordance with the present invention primarily uses the vertical vectors with assistance of the horizontal vectors. The detection of the sensing microswitch will achieve the sampling effect. The successive digital signals of the OFF/ON status are in turn accumulated by the calculator, and are then indicated on the LCD display board through an I/O circuit, thereby completely excluding the possibility of calculating the values erroneously, and thereby efficiently enhancing the using effect of the pen type step calculating device.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A pen type step calculating device comprising:
a barrel (1) having an upper portion and a lower portion, an opening (10) defined in said upper portion of said barrel (1);
a transparent outer cover (11) mounted in said opening (10) of said barrel (1);
a battery sleeve (12) mounted in said upper portion of said barrel (1) and containing at least one battery (121) therein;
a sensing circuit board (2) mounted in said upper portion of said barrel (1) and connected to said battery sleeve (12); and
a press button switch (13) mounted in said upper portion of said barrel (1) and connected to said sensing circuit board (2);
wherein, said sensing circuit board (2) includes:
an LCD display board (20) for providing display of steps/distance/heat capacity;
a sensing microswitch (21) respectively for detecting changes of vertical vectors and horizontal vectors;
an LED (23) for providing status display;
a calculator (24) for receiving digital signals to execute an accumulative operation;
a comparator (25) for providing comparison of values; and
a decoder (26) containing an operation unit therein.

2. The pen type step calculating device in accordance with claim 1, further comprising a spring (28) mounted in said upper portion of said barrel (1) and connected between said battery sleeve (12) and a first end of said sensing circuit board (2), and an electrode (29) mounted in said upper portion of said barrel (1) and connected between said press button switch (13) and a second end of said sensing circuit board (2).

3. The pen type step calculating device in accordance with claim 1, wherein said press button switch (13) has a single cylindrical press button type.

4. The pen type step calculating device in accordance with claim 1, wherein said press button switch (13) includes a large circle (131) and a small circle (132).

5. The pen type step calculating device in accordance with claim 1, wherein said sensing circuit board (2) further includes a load (27).

6. The pen type step calculating device in accordance with claim 5, wherein said load (27) is a buzzer.

7. The pen type step calculating device in accordance with claim 5, wherein said load (27) is a motor.
